(19) United States
(12) Patent Application Publication
(10) Pub. No.: US 2015/0332597 A1
(43) Pub. Date: Nov. 19, 2015

(54) METHOD AND SYSTEM FOR PROVIDING EDUCATION CONTENTS

(71) Applicant: KT Corporation, Seongnam-si (KR)

(72) Inventors: Hyun-Sook KIM, Seoul (KR); Eun-Hye LEE, Seoul (KR); Hyun-Pyo KIM, Seoul (KR); Jin-Su JUNG, Gunpo-si (KR)

(73) Assignee: KT CORPORATION, Seongnam-si (KR)

(21) Appl. No.: 14/807,779

(22) Filed: Jul. 23, 2015

Related U.S. Application Data
(63) Continuation of application No. 13/660,792, filed on Oct. 25, 2012.

(30) Foreign Application Priority Data
Oct. 25, 2011 (KR) 10-2011-0109222

(51) Int. Cl. G09B 7/00

(52) U.S. Cl. CPC G09B 7/00

(57) ABSTRACT

A method and an apparatus of providing education contents are provided. The method includes transmitting education contents to a display device in response to an education contents request received from the display device, receiving, from a personal device, a personal request that is associated with the education contents and comprises an education contents identifier of the education contents, generating a personal response to the personal request received from the personal device and transmitting the generated personal response to the personal device.

### CROSS-REFERENCE TO RELATED APPLICATION

This application is a continuation of U.S. application Ser. No. 13/660,792 filed Oct. 25, 2012, which claims priority from the Korean Patent Application No. 10-2011-0109222, filed on Oct. 25, 2011 in the Korean Intellectual Property Office, the entire disclosure of which is incorporated herein by reference in its entirety.

### BACKGROUND

1. Field

Exemplary embodiments broadly relate to a method and a system for providing education contents, and more particularly, exemplary embodiments relate to a method and a system for providing various information about education contents to multiple devices.

2. Description of the Related Art

With recent development of video education services provided online, various contents of online education have been provided to a number of users. A video education service according to a related art has been provided to a user through one device, e.g., a TV, a desktop, and a notebook.

According to the related art, one device receives inquiries from an individual user and provides replies thereto, and grades, in addition to videos for education to the individual user. Thus, if authentication is executed by using only an identifier of an individual user, such as identification (ID) and passwords, irrespective of a type of a device, the inquiries, replies and grades may be exposed to a third party, and not the user.

### SUMMARY

Accordingly, it is an aspect to provide a method and a system for providing a user with education contents, which can be shared by multiple users, through a display device such as a TV and a PC, and providing a response such as a grade and a reply to an inquiry to a device authenticated as a device of the user, so as to enhance security of the response about the user.

According to an aspect of exemplary embodiment, there is provided a method of providing education contents by an education contents providing apparatus. The method comprises transmitting education contents to a first device in response to a first request received from the first device, receiving, from a second device, a second request that is associated with the education contents and comprises an identifier related to the education contents, generating a response to the second request received from the second device and transmitting the generated response to the second device.

According to yet another aspect of an exemplary embodiment, there is provided an apparatus for providing education contents. The apparatus includes a transmitter configured to transmit education contents to a first device in response to a first request received from the first device, an authenticator configured to authenticate a second device based on a second request that comprises a first identifier and a second identifier, wherein the second request is received from the second device and a manager configured to generate a second response to the second request and provide the generated response to the second device.

According to yet another aspect of an exemplary embodiment, there is provided a method of providing information about education contents. The method includes receiving information about education contents that is displayed by a device, receiving a request that is associated with the education contents by input, wherein the request comprises a device identifier, transmitting the request to an apparatus and receiving a response generated in response to the request from the apparatus.

According to yet another aspect of an exemplary embodiment, there is provided a system for providing education contents. The system comprises: a display device which displays questions of an exam; a first terminal which receives a plurality of inputs from a user and transmits the plurality of inputs, the plurality of inputs being answers to the questions of the exam; and a server which receives the plurality of answers and transmits a grade based on a number of correct answers to the questions, to the first terminal, and the server transmits the exam to the display device, wherein the grade is transmitted after authenticating the first terminal based on an identifier of the user and an identifier of the first terminal.

In exemplary embodiments, identical education contents shared with multiple users are provided through a display device such as a TV and a PC, whereas grade of an individual user, and reply to the inquiry, etc. are provided through a personal device authenticated as a personal device of the user. Accordingly, when providing education contents, the security for the personal response about the user can be enhanced.

### BRIEF DESCRIPTION OF THE DRAWINGS

Non-limiting and non-exhaustive exemplary embodiments will be described in conjunction with the accompanying drawings. Understanding that these drawings depict only exemplary embodiments and are, therefore, not to be intended to limit its scope, the exemplary embodiments will be described with specificity and detail taken in conjunction with the accompanying drawings, in which:

FIG. 1 is a view illustrating a configuration of an education contents providing system according to an exemplary embodiment;

FIG. 2 is a flow diagram illustrating a method of providing education contents according to an exemplary embodiment;

FIG. 3 is a block diagram illustrating an education contents providing apparatus according to an exemplary embodiment;

FIG. 4 is a block diagram illustrating a personal request manager according to an exemplary embodiment; and

FIG. 5 is a block diagram illustrating a personal request manager according to another exemplary embodiment.

### DETAILED DESCRIPTION OF EXEMPLARY EMBODIMENTS

Hereinafter, exemplary embodiments will be described in detail with reference to the accompanying drawings to be readily implemented by those skilled in the art. However, it is to be noted that the present disclosure is not limited to the exemplary embodiments, but can be realized in various other ways. In the drawings, certain parts not directly relevant to the description of exemplary embodiments are omitted to enhance the clarity of the drawings, and like reference numerals denote like parts throughout the whole document.

Through the whole document, the term “connected to” or “coupled to” that is used to designate a connection or coupling of one element to another element includes both a case that an element is “directly connected or coupled to” another element and a case that an element is “electronically connected or coupled to” another element via still another element. Further, the term “comprises or includes” and/or “comprising or including” used in the document means that one or more other components, steps, operation and/or existence or addition of elements are not excluded in addition to the described components, steps, operation and/or elements.

Hereinafter, exemplary embodiments will be explained in detail by reference to the accompanying drawings.

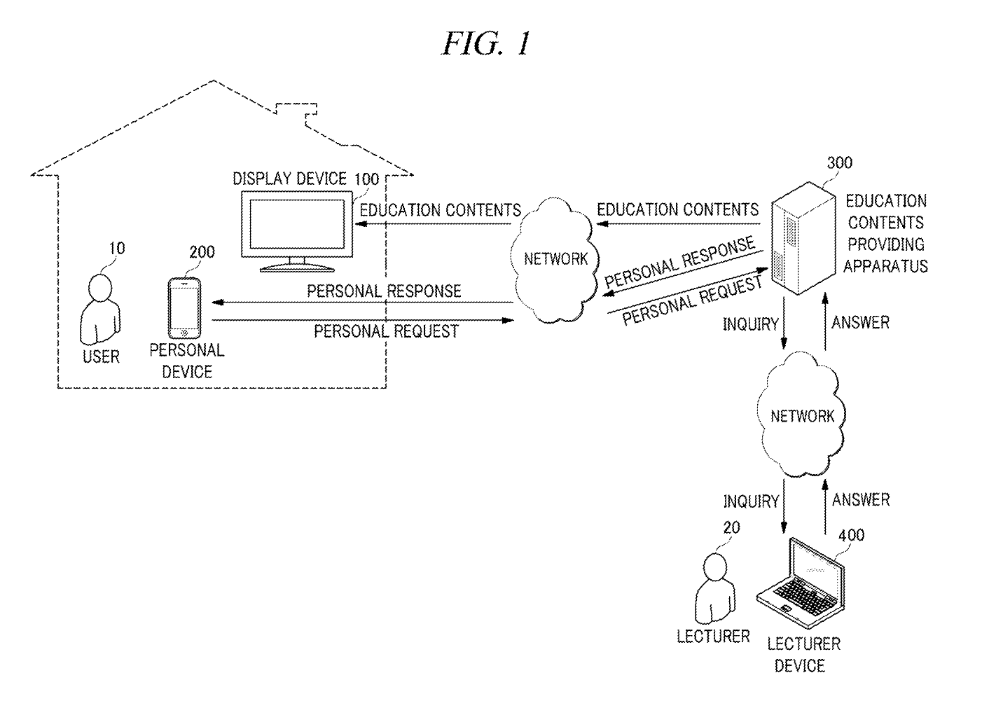

FIG. 1 is a view illustrating a configuration of an education contents providing system according to an exemplary embodiment.

A display device 100 may receive education contents, e.g., education contents, from an education contents providing apparatus 300, and display the received education contents to provide the contents to a user 10.

The display device 100 may provide the education contents received from the education contents providing apparatus 300 to another user (not illustrated) placed around the display device 100, as well as to the user 10. In another exemplary embodiment, the education contents providing apparatus 300 is a server.

While receiving the education contents through the display device 100, the user 10 may receive information related to the education contents through a personal device 200. The user 10 may transmit a personal request, e.g., an answer to examination questions provided through education contents or an inquiry associated with the education contents, to the education contents providing apparatus 300 through the personal device 200.

The personal device 200 may execute an application that interacts with the education contents according to a request by the user 10, and provide the user 10 with an interface for the education contents, e.g., an answer sheet interface and an inquiry interface. In an exemplary embodiment, the personal device 200 is a user terminal.

When the personal device 200 receives a request for execution of the application interacted with the education contents from the user 10 by a user input, the personal device 200 may acquire information of the education contents being displayed through the display device 100 from the display device 100 via near field communication. According to circumstances, the personal device 200 may acquire the information of the education contents being displayed through the display device 100 from the education contents providing apparatus 300, and not, the display device 100.

In response to the personal request received from the personal device 200, the education contents providing apparatus 300 may determine whether the personal device 200 is a device registered for the user 10, by using an identifier of the personal device 200.

As result of the determination, if the personal device 200 is a device registered for the user 10, the education contents providing apparatus 300 may generate a personal response to the personal request received from the personal device 200, and transmit the generated personal response to the personal device 200.

If the personal request received from the personal device 200 may include answers to examination questions included in the education contents, the education contents providing apparatus 300 may generate a grade for the answers, i.e., grade including results obtained by grading the answers included in the answer sheet, and transmit the grade to the personal device 200. In an exemplary embodiment, the grade may be based on a number of correct answers.

If the personal request received from the personal device 200 includes an inquiry associated with the education contents, the education contents providing apparatus 300 may transmit the inquiry to a lecturer device 400 registered for a lecturer 20. In an exemplary embodiment, the lecturer device 400 is a second terminal. The lecturer 20 may be a person who has participated in a lecture included in the education contents. The lecturer 20 may confirm the inquiry through the lecturer device 400, input an answer to the inquiry, and transmit the input answer to the education contents providing apparatus 300.

In an exemplary embodiment, the education contents providing apparatus 300 may provide contents, which are identically provided to multiple users using education contents, through a display device such as a TV and a PC. Also, the education contents providing apparatus 300 may provide grade and reply to inquiries to the personal device 200, which is authenticated as a personal device of each user by using the identifier of the personal device. Accordingly, the security for the personal request of the user can be enhanced.

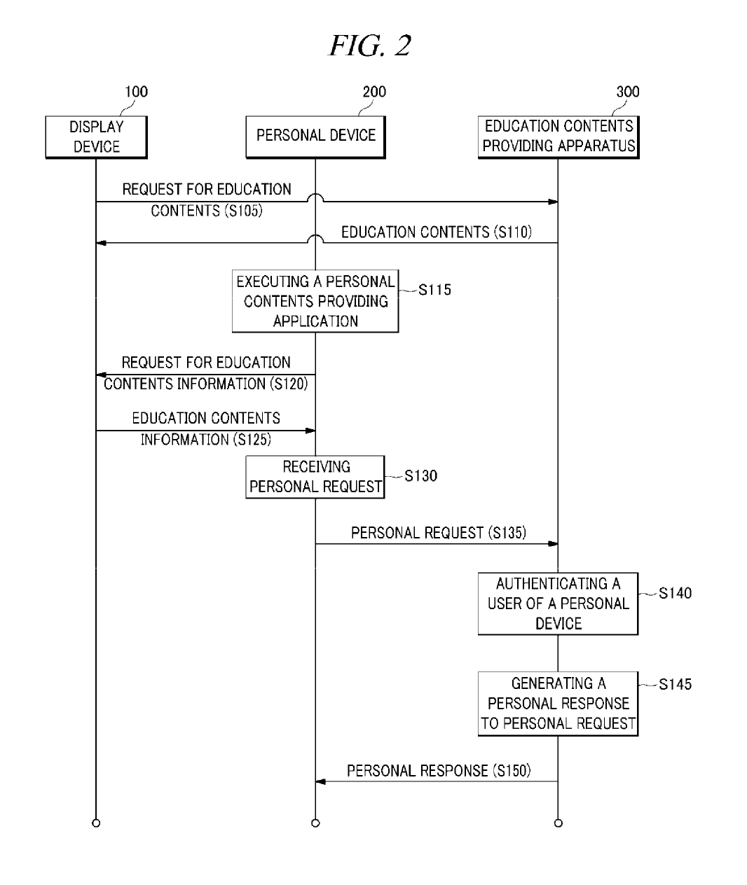

FIG. 2 is a flow diagram illustrating a method of providing education contents according to an exemplary embodiment.

In operation S105, the display device 100 may request providing education contents to the education contents providing apparatus 300. The display device 100 may request providing the education contents to the education contents providing apparatus 300 by using an identifier of the education contents selected by input of a user (not illustrated). The display device 100 may transmit an identifier of the user, e.g., information of ID and passwords, to the education contents providing apparatus 300 together with the request for providing education contents.

In operation S110, the education contents providing apparatus 300 may provide the requested education contents to the display device 100 in response to the request for providing education contents received in operation S105. The education contents providing apparatus 300 may search the education contents by using the identifier of the education contents received in operation S105 together with the request for providing education contents, and provide the education contents to the display device 100. If the identifier of the user is received together with the request for providing education contents, the education contents providing apparatus 300 may determine whether the user is a reasonable user for the education contents, by using the received identifier of the user.

The display device 100 may provide the education contents received in operation S110 to the user by displaying the education contents on a screen or the like.

In operation S115, the personal device 200 may execute a personal contents providing application provided in the personal device 200 based on input of a user. That is, the personal device 200 may execute the application for providing personal contents to the user, corresponding to the education contents being displayed in the display device 100 by input of a user.

The personal contents providing application executed by the personal device 200 may provide an interface for providing personal contents to the user, e.g., an answer sheet interface, an inquiry interface, a grade interface, and a reply interface.

In operation S120, the personal device 200 may transmit a request, to the display device 100, for information of the education contents being displayed by the display device 100. That is, when the personal contents providing application is executed in operation S115, the personal device 200 may request information of the education contents being currently displayed to the display device 100 in order to determine which education contents the display device 100 used by the user are providing to the user.

In operation S125, in response to the request for providing information of education contents received in operation S120, the display device 100 may provide the personal device 200 with the information of the education contents being displayed to the user through the display device 100.

In an exemplary embodiment, the personal device 200 may acquire the information of the education contents being displayed by the display device 100 directly from the display device 100. However, the exemplary embodiment is not limited thereto. The personal device 200 may request, to the education contents providing apparatus 300, the information of the education contents displayed by the display device 100 by using the identifier of the user or an identifier of the personal device, and acquire the requested information of the education contents from the education contents providing apparatus 300.

In operation S130, the personal device 200 may receive input for personal request from the user. That is, the personal device 200 may receive, from the user, input of a personal request, e.g., input of an answer to examination questions and input of inquiries, through personal request input means, e.g., an answer sheet interface and an inquiry interface, provided to the user by the personal contents providing application executed in operation S115.

In operation S135, the personal device 200 may transmit the personal request received in operation S130 to the education contents providing apparatus 300. The personal device 200 may transmit the identifier of the education contents, the identifier of the personal device 200 and the identifier of the user to the education contents providing apparatus 300 together with the personal information.

In operation S140, the education contents providing apparatus 300 may determine whether the personal device 200 is matched with the user capable of receiving a personal response to the personal request, by using the identifier of the personal device included in the personal request received in operation S135, e.g., mobile phone numbers, Universal Subscriber Identity Module (USIM) card numbers, and device unique numbers such as an International Mobile Equipment Identity (IMEI) number or a Media Access Control (MAC) address. Therefore, in an exemplary embodiment, the personal device is a mobile phone or a wireless communication device.

That is, the education contents providing apparatus 300 may determine whether the user of the personal device 200 is a reasonable user, i.e., an authorized user, that can receive, i.e., is permitted or authorized to receive, the personal response to the personal request for the education contents.

The education contents providing apparatus 300 may execute authentication for the personal device 200 by comparing the identifier of the personal device 200 received together with the personal request to the identifier of at least one device stored in a database while being matched with the user.

The education contents providing apparatus 300 does not determine the authorization to receive personal response to the personal request only based on the identifier of the user. The education contents providing apparatus 300 determines whether the device that has transmitted the personal request is included in at least one personal device pre-set to be personally used by the user, by using the identifier of the personal device that has transmitted the personal request. Thus, through the aforementioned authentication process, it is possible to prevent the identifier of the user from being exposed, thereby preventing exposure of the personal information of the user to a third party.

The education contents providing apparatus 300 may store the personal request received in operation S135 while matching the personal request with the user of the authenticated personal device 200.

In operation S145, if it is determined that the personal device 200 is the device that can receive the personal response to the personal request, the education contents providing apparatus 300 generates the personal response to the personal request received in operation S135.

If the personal request received in operation S135 includes answers to examination questions associated with the education contents, the education contents providing apparatus 300 may generate the personal response including grade corresponding to the answers.

If the personal request received in operation S135 includes an inquiry associated with the education contents, the education contents providing apparatus 300 may generate the personal response including reply to the inquiry. The education contents providing apparatus 300 may generate the personal response including reply to the inquiry by using an answer received from the lecturer device matched with the education contents.

In operation S150, the education contents providing apparatus 300 may transmit the personal response generated in operation S145 to the personal device 200 to provide the personal response to the user.

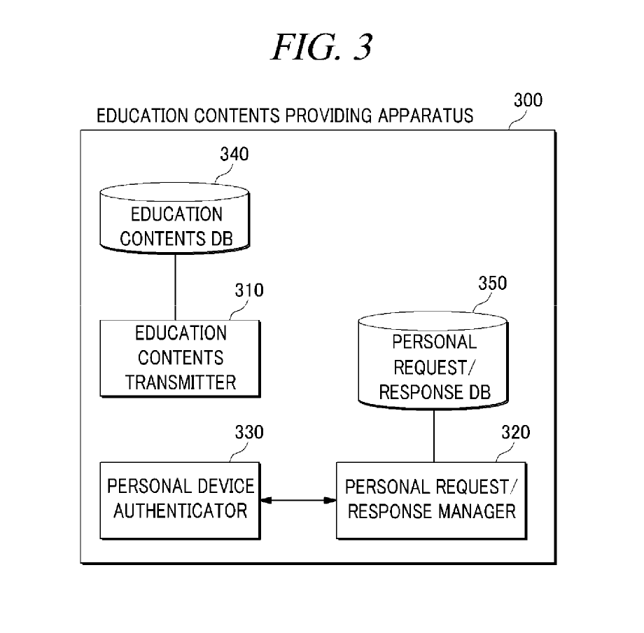

FIG. 3 is a block diagram illustrating an education contents providing apparatus according to an exemplary embodiment.

The education contents providing apparatus 300 according to an exemplary embodiment may include an education contents transmitter 310, a personal request/response manager 320, a personal device authenticator 330, an education contents database 340, and a personal request/response database 350.

The education contents transmitter 310 may acquire education contents requested by a display device (not illustrated) from the education contents database 340, and provide the acquired education contents to the display device. The education contents transmitter 310 may receive an identifier of the education contents and an identifier of a user who wants to receive the education contents through the display device, together with the request for the education contents. Based on the identifier of the education contents and the identifier of the user that have been received, the education contents transmitter 310 may acquire the education contents and provide the acquired education contents to the display device.

The personal request/response manager 320 may receive personal request from a personal device (not illustrated), and generate a personal response to the received personal request to provide the personal response. The personal request that the personal request/response manager 320 may receive from the personal device may include the identifier of the education contents provided by the education contents transmitter 310 to the display device and an identifier of the personal device that has transmitted the personal request.

Accordingly, the personal request/response manager 320 may transmit the identifier of the education contents and the identifier of the personal device, which are included in the personal request, to the personal device authenticator 330 to request authentication for the personal device. If the personal device corresponds to the display device that has received the education contents through the education contents transmitter 310, the personal information request/response manager 320 may generate the personal response to the personal request received from the personal device, and transmit and provide the personal response to the personal device.

As described above, the personal request and the personal response thereto may include the personal information that should not be exposed to a third party. Accordingly, the personal request/response manager 320 may transmit the personal response to the personal device only if the personal device authenticator 330 determines that the personal device that has transmitted the personal request corresponds to the object that can receive the personal response to the personal request.

The personal device authenticator 330 may determine whether the personal device that has transmitted the personal request corresponds to the display device that has received the education contents through the education contents transmitter 310, by using the identifier of the education contents and the identifier of the personal device that have been received from the personal request/response manager 320.

That is, the personal device authenticator 330 may execute authentication for the personal device by identifying the user who receives the education contents by using the identifier of the education contents, and determining whether the personal device is included in the devices set to be matched with the user identified to have received the education contents by using the identifier of the personal device.

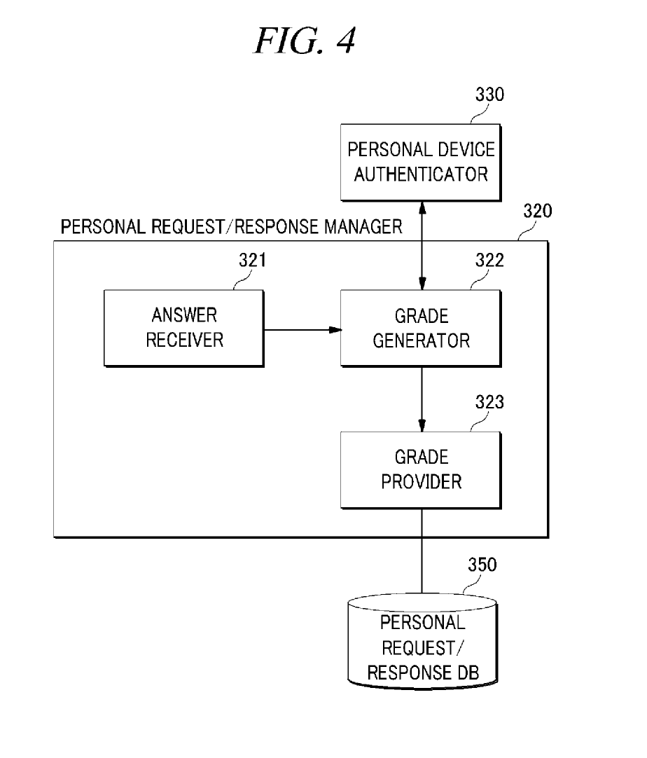

FIG. 4 is a block diagram illustrating a personal request manager according to an exemplary embodiment.

The personal request/response manager 320 may include an answer receiver 321, a grade generator 322, and a grade provider 323.

The answer receiver 321 may receive answers to examination questions included in the personal request from the personal device. The answers may include an answer sheet, an identifier of education contents related to the answers, and an identifier of the personal device, and be transmitted to the grade generator 322.

The grade generator 322 may request, to the personal device authenticator 330, authentication of the personal device that has transmitted the answers, by using the identifier of the education contents and the identifier of the personal device that have been received from the answer receiver 321.

If the personal device authenticator 330 determines that the personal device that has transmitted the answers corresponds to the display device that has received the education contents from the education contents transmitter 310, the grade generator 322 may generate a grade corresponding to the answers. The grade generated by the grade generator 322 may include information obtained from analysis of the answers such as an explanation for incorrect answers among the answers by the user, and a percentage of correct answers depending on types of inquiries.

The grade provider 323 may transmit the grade generated by the grade generator 322 to the personal device that has transmitted the answers, and store the transmitted grade in the personal request/response database 350 while matching the grade with the personal device or the user of the personal device.

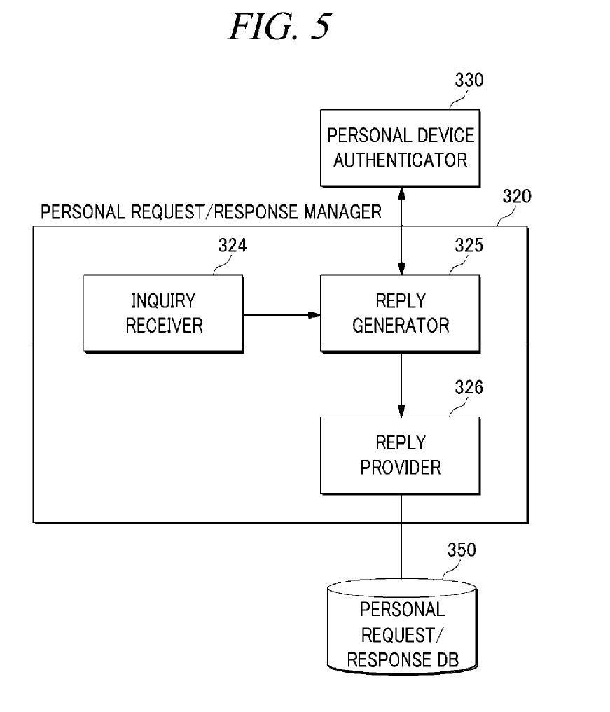

FIG. 5 is a block diagram illustrating a personal request manager according to another exemplary embodiment.

The personal request/response manager 320 according to an exemplary embodiment may include an inquiry receiver 324, a reply generator 325, and a reply provider 326.

The inquiry receiver 324 may receive an inquiry included in the personal request from the personal device. The inquiry may include an identifier of education contents related to the inquiry, and an identifier of the personal device, and be transmitted to the reply generator 325.

The reply generator 325 may request, to the personal device authenticator 330, authentication of the personal device that has transmitted the inquiry, by using the identifier of the education contents and the identifier of the personal device that have been received from the inquiry receiver 324.

If the personal device authenticator 330 determines that the personal device that has transmitted the inquiry corresponds to the display device that has received the education contents through the education contents transmitter 310, the reply generator 325 may generate a reply to the inquiry. The reply generated by the reply generator 325 may be generated based on an answer received in response to the inquiry from a device registered as a lecturer device for the education contents related to the inquiry.

That is, the reply generator 325 may transmit the inquiry to the device registered as the lecturer device for the education contents related to the inquiry, and receive the answer to the inquiry from the lecturer device. Based on the received answer, the reply generator 325 may generate the reply.

The reply provider 326 may transmit the reply generated by the reply generator 325 to the personal device that has transmitted the inquiry, and store the transmitted reply in the personal request/response database 350 while matching the reply with the personal device or the user of the personal device.

The exemplary embodiment can be embodied in a storage medium including instruction codes executable by a computer such as a program module executed by the computer. Besides, the data structure according to the exemplary embodiment can be stored in the storage medium executable by the computer. A computer readable medium can be any usable medium which can be accessed by the computer and includes all volatile/non-volatile and removable/non-removable media. Further, the computer readable medium may include all computer storage and communication media. The computer storage medium includes all volatile/non-volatile and removable/non-removable media embodied by a certain method or technology for storing information such as computer readable instruction code, a data structure, a program module or other data. The communication medium typically includes the computer readable instruction code, the data structure, the program module, or other data of a modulated data signal such as a carrier wave, or other transmission mechanism, and includes a certain information transmission medium.

The above description is provided for the purpose of illustration, and it would be understood by those skilled in the art that various changes and modifications may be made without changing technical conception and essential features of the present disclosure. Thus, it is clear that the above-described exemplary embodiments are illustrative in all aspects and do not limit the present disclosure. For example, each component described to be of a single type can be implemented in a distributed manner Likewise, components described to be distributed can be implemented in a combined manner.

The scope of the present disclosure is defined by the following claims rather than by the detailed description of the exemplary embodiment. It shall be understood that all modifications and embodiments conceived from the meaning and scope of the claims and their equivalents are included in the scope of the present disclosure.

What is claimed is:

1. An education contents providing system comprising:
a display device configured to receive education contents from an education contents providing server, and to display the education contents, the display device including at least one of a TV and a PC;
a personal device configured to receive an information of the education contents from the display device, and to transmit a personal request related to the education contents to the education contents providing server, the personal device including at least one of a mobile phone and a wireless communication device; and
the education contents providing server configured to transmit the education contents to the display device, to receive the personal request from the personal device, and to transmit to the personal device a personal response corresponding to the personal request.

2. The education contents providing system of claim 1, wherein the display device displays the education contents to and the personal device receives the personal request from a same user.

3. The education contents providing system of claim 1, wherein the personal request includes at least one of an answer to an examination question provided through the education contents and an inquiry associated with the education contents

4. The education contents providing system of claim 3, wherein the personal response includes at least one of a grade for the answer and a reply to the inquiry.

5. The education contents providing system of claim 4, wherein the personal device executes an application providing a user with at least one of an answer sheet interface, an inquiry interface, a grade interface and a reply interface.

6. The education contents providing system of claim 1, wherein the personal device transmits to the education contents providing server an identifier of the education contents together with the personal request.

7. The education contents providing system of claim 1, wherein the personal device transmits to the education contents providing server at least one identifier of an identifier of the personal device and an identifier of a user.

8. The education contents providing system of claim 7, wherein the education contents providing server executes authentication based on the at least one identifier.

9. The education contents providing system of claim 1, wherein the personal device receives the information from the display device through a near field communication.

10. The education contents providing system of claim 1, wherein the personal device receives from the display device the information related to the education contents being currently displayed by the display device.

11. A method of providing education contents by a personal device including at least one of a mobile phone and a wireless communication device, the method comprising:
receiving, from a display device including at least one of a TV and a PC, an information of education contents being displayed by the display device;
receiving from a user an input for a personal request related to the education contents; and
transmitting the personal request to an education contents providing server.

12. The method of claim 11, wherein the display device displays the education contents to the user.

13. The method of claim 12, wherein the method further includes receiving from the education contents providing server a personal response corresponding to the personal request.

14. The method of claim 13, wherein the personal request includes at least one of an answer to an examination question provided through the education contents and an inquiry associated with the education contents

15. The method of claim 14, wherein the personal response includes at least one of a grade for the answer and a reply to the inquiry.

16. The method of claim 15, wherein the personal device executes an application providing the user with at least one of an answer sheet interface, an inquiry interface, a grade interface and a reply interface.

17. The method of claim 13, wherein the transmitting includes transmitting an identifier of the education contents to the education contents providing server.

18. The method of claim 13, wherein the transmitting includes transmitting at least one identifier of an identifier of the personal device and an identifier of the user to the education contents providing server.

19. The method of claim 18, wherein the education contents providing server executes authentication based on the at least one identifier.

20. The method of claim 13, wherein the personal device receives the information from the display device through a near field communication.
